(19) United States
(12) Patent Application Publication
(10) Pub. No.: US 2008/0110218 A1
(43) Pub. Date: May 15, 2008

(54) Shutter Assembly With Sliding T-Lock

(75) Inventors: Clyde Allen, Lapeer, MI (US); Nathan Greenway, Attica, MI (US); Brad Kutler, Lake Orion, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: The Tapco International Corporation, Wixom, MI (US)

(21) Appl. No.: 11/940,100

(22) Filed: Nov. 14, 2007

Related U.S. Application Data
(60) Provisional application No. 60/865,663, filed on Nov. 14, 2006.

(51) Int. Cl. E06B 9/02

(52) U.S. Cl. 70/158; 52/202; 70/262

(57) ABSTRACT

A locking shutter assembly includes a pair of shutters for attachment to a building structure. A pair of retention brackets extend between a first and a second end. One of the retention brackets are attached to a respective shutter at each end with a pair of opposing clips. Each retention bracket defines a passage and a rigidity member is slidably disposed in the passage to interconnect the retention brackets and restrain movement of the shutters with respect to the structure during inclement weather.

### CROSS-REFERENCE TO RELATED APPLICATION

The present application claims priority to U.S. Provisional Patent Application Ser. No. 60/865,663, filed Nov. 14, 2006, the entire specification of which is expressly incorporated herein by reference.

### FIELD OF THE INVENTION

The subject invention generally relates to a shutter assembly and more particularly to a reinforced shutter assembly having a sliding T-lock for withstanding inclement weather.

### BACKGROUND OF THE INVENTION

Various locking assemblies for shutters are known in the art. It is generally known that locking assemblies are utilized, when necessary, to lock pairs of shutters in a closed position on a dwelling. Shutters are used for both aesthetic and functional purposes on the dwelling. In the closed position, the shutters function to protect windows, doors, and other openings of the dwelling during inclement weather, such as precipitation storms, wind storms, and hurricanes.

During such inclement weather, it is pertinent to lock, or retain, the shutters in the closed position such that the shutters can continue to provide adequate protection to the windows, doors, and other openings during and throughout the inclement weather. If the weather causes the shutters to open then the functional purpose of the shutters is defeated.

Conventional assemblies for locking pairs of shutters in the closed position are deficient for many reasons. For instance, the locking assemblies of the prior art do not adequately retain the shutters in the closed position throughout the inclement weather. In these assemblies, wind either bends or breaks the assembly causing the shutters to open. Also, many conventional locking assemblies require excessive modification such as direct drilling into and through the shutters to adequately retain the shutters in the closed position. In these assemblies the fastener(s) extends through at least a portion of the shutters. As a result and to a varying degree, these conventional locking assemblies damage the shutters such that, after the inclement weather, the aesthetic purpose of the shutters is negatively impacted.

Furthermore, some conventional locking assemblies, also referred to in the art as storm or locking bars, create an emergency egress issue that prevents occupants of the dwelling from escaping during an emergency, such as a fire. More specifically, a conventional storm bar is mounted across the shutters once the shutters have been closed. The storm bar is secured, typically screwed, into the dwelling on each side of the closed shutters to prevent the shutters from opening during the inclement weather. Screws are also used to connect the shutters to the storm bar such that the shutters can not be blown, or otherwise deflected, inward, i.e., toward the dwelling, during the inclement weather. With the storm bar screwed to the dwelling and the shutter screwed to the storm bar, the occupants of the dwelling cannot open a window or door from within the dwelling to release the storm bar and escape.

Due to the deficiencies in the locking assemblies of the prior art, including those described above, it is desirable to provide a novel locking assembly for shutters that adequately retains the shutters in a closed position on a dwelling such that protection to a window, door, or other opening is maximized throughout any inclement weather. It is also desirable to provide a locking assembly for shutters that can easily be pre-arranged during installation to unlock and open from a pre-selected side and when unlocked is clear of the opening.

### SUMMARY OF THE INVENTION

A first aspect of the invention provides a shutter sub-assembly for locking a first and a second shutter in a closed position on a structure. The sub-assembly comprises a first retention bracket extending between a first and a second end and defining a passage extending between the ends with the first retention bracket for attachment to the first shutter and a second retention bracket extending between a first and a second end and defining a passage extending between the ends with the second retention bracket for attachment to the second shutter with the first end of the second retention bracket for disposition adjacent the second end of the first retention bracket to align the passage of the first retention bracket with the passage of the second retention bracket. A rigidity member extends longitudinally and is for sliding engagement within the passage of the first and second retention bracket to interconnect the first retention to the section retention bracket and restrain movement of the shutters with respect to the structure.

A second aspect of the invention provides a locking shutter assembly. The assembly comprises a first shutter for attachment to a building structure and a first retention bracket extending between a first and a second end and defining a passage extending between the ends with the first retention bracket disposed on the first shutter. The assembly also comprises a second shutter for attachment to the building structure, adjacent the first shutter and a second retention bracket extends between a first and a second end and defines a passage extending between the ends with the second retention bracket disposed on the second shutter with the first end of the second retention bracket disposed adjacent the second end of the first retention bracket such that the passages of the first and the second retention brackets are aligned to form a single continuous passage. A rigidity member is disposed in the single continuous passage of the first and the second retention bracket and interconnects the first retention bracket to the second retention bracket and restrains movement of the shutters with respect to the structure.

A third aspect of the invention provides a method of locking shutters in a closed position to cover an opening on a structure. The method comprises the steps of attaching a first retention bracket to a first shutter where the first retention bracket defines a passage, attaching a second retention bracket to a second shutter where the second retention bracket defines a passage, and sliding an elongated rigidity member through the passages of both of the first and the second retention bracket to lock the shutters in the closed position.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a perspective view of a shutter assembly embodying the present invention and applied in the environment of a dwelling

FIG. 2 is an inside view of the shutter assembly in a closed position;

FIG. 3 is a side view of the shutter assembly;

FIG. 4 is an outside view of the shutter assembly in the closed position;

FIG. 5 is an exploded perspective view of the shutter assembly;

FIG. 6 is a perspective view of the shutter assembly in the closed position;

FIG. 7 is a top view of a clip of a locking device of the shutter assembly;

FIG. 8 is a side view of the clip;

FIG. 9 is an end view of a bracket of the locking device;

FIG. 10 is an enlarged partial view of the bracket taken from circle 10 of FIG. 9;

FIG. 11 is an end view of a rigidity member of the locking device;

FIG. 12 an enlarged perspective view of the assembly taken from circle 12 of FIG. 6;

FIG. 13 is a perspective side view of a clip of the locking device secured to the shutter via a fastener extending through a hole in the clip;

FIG. 14 is a partial perspective view of the clip of the locking device secured to the shutter via the fastener extending through a notch in the clip; and

FIG. 15 is a perspective view of a modified assembly.

### DETAILED DESCRIPTION OF THE PREFERRED EMBODIMENT

Referring to the Figures, wherein like numerals indicate like or corresponding parts throughout the several views, a locking shutter assembly 20 of the present invention has a French door or shutter set 22 preferably having a first shutter 24 and a second shutter 26. The shutters 24, 26 preferably mount pivotally to the exterior of a structure 28 such as an industrial building or dwelling to cover an opening 30 of the structure 28 such as a window. Alternatively, the shutters 24, 26 may slide open and closed similar to that of a traditional sliding French door arrangement and/or similar to that disclosed in U.S. patent application Ser. No. 11/428,739, titled: “Shutter Assembly,” filed Jul. 5, 2006, assigned to the same assignee as the present invention, and incorporated herein by reference in its entirety.

When the shutters 24, 26 are in an open position 32 during mild weather conditions, they preferably lay flat to the structure 28 so as not to obstruct the opening. When in a closed position 34, the shutter assembly 20 covers the opening 30 and protects the windows and/or doors in the opening from inclement weather, such as precipitation storms, wind storms, and hurricanes. To accomplish this protection, the shutter assembly 20 has a locking device 36 that reinforces and locks closed the shutter set 22 of the assembly 20.

The shutters 24, 26 preferably pivot in opposite directions to one-another and along a respective axis 38, 40 when closing to cover the opening 30 during inclement weather. The locking device 36 of the assembly 20 is generally integrated directly into both the left and right shutters 24, 26 and preferably is free of the structure 28 so that when the shutters are in the open position 32, and thus the device is generally or substantially removed, the opening 30 in the building 28 is not obstructed by any portion of the assembly 20 including the device 36.

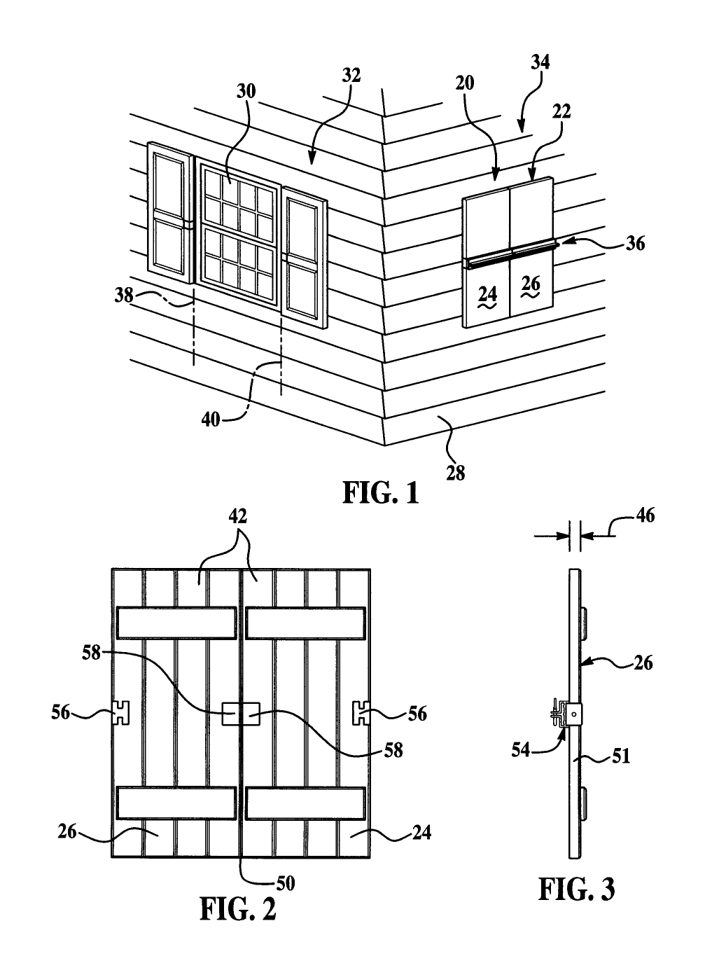

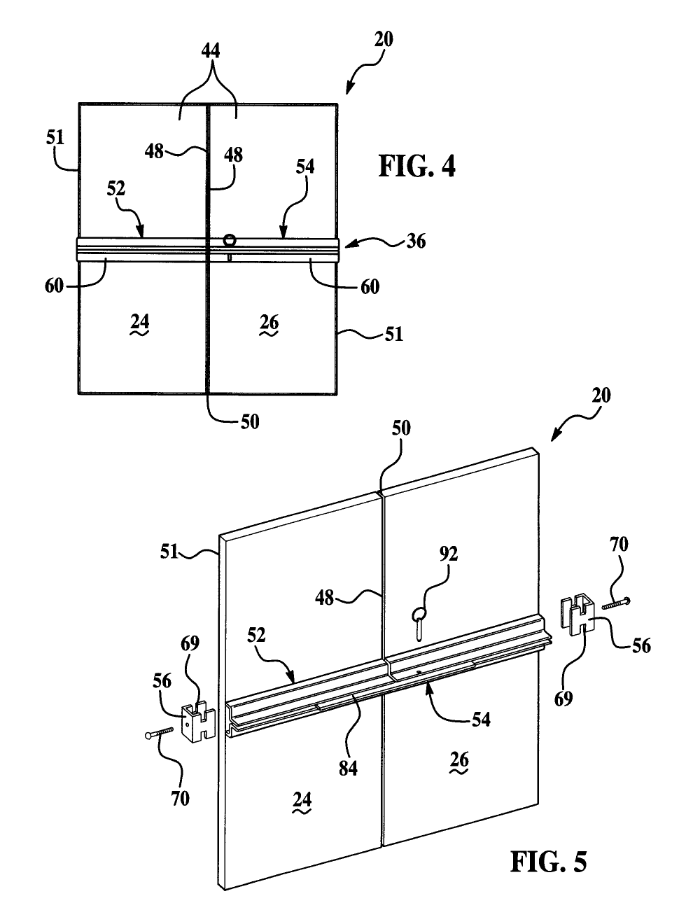

Referring to FIGS. 2-5 and when the set of shutters 22 are in the closed position 34, each shutter 24, 26 has and carries a respective first or inside surface 42 and a respective second or outside surface 44 separated generally by a shutter thickness or length 46. The thickness 46 of the shutters 24, 26 is generally equal to the width of respective distal edge faces 48 carried by the respective shutters and that face one another and define an elongated and substantially vertical gap 50 between one-another when the shutter set 22 is in the closed position 34. Each shutter 24, 26 also has an opposite edge face 51 that generally co-extends with respective pivoting axis 38, 40.

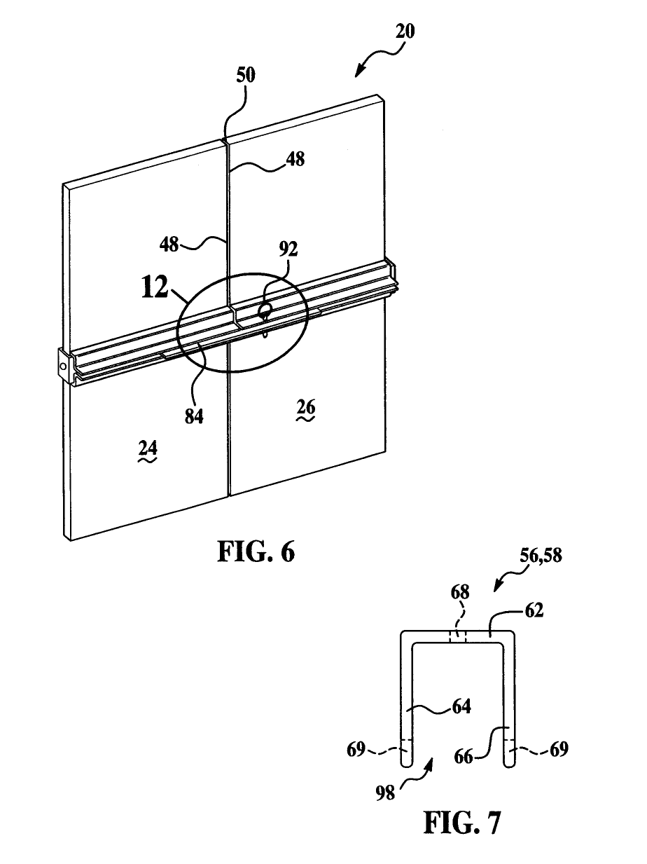

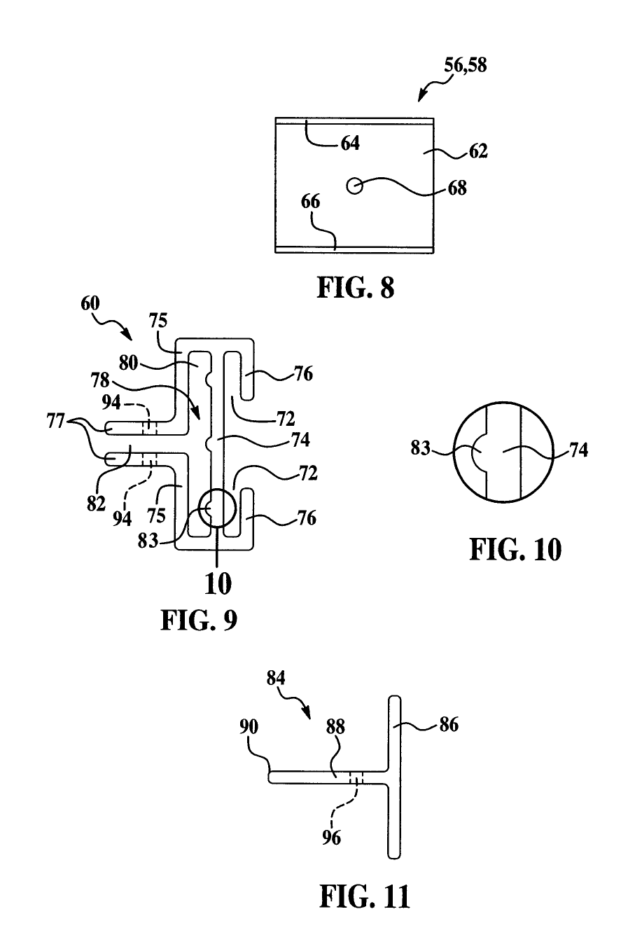

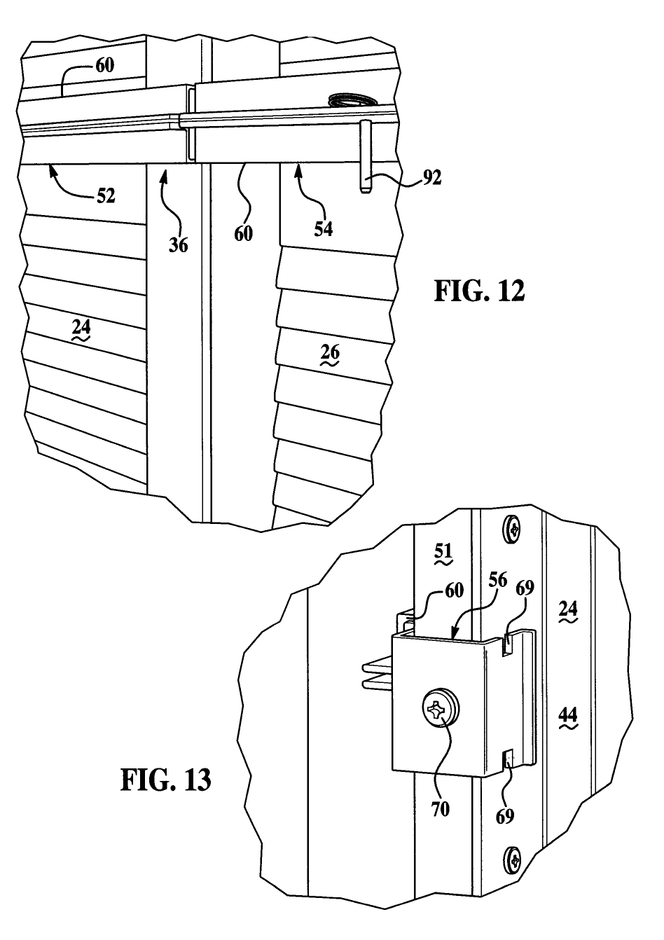

Referring to FIGS. 2-6 and 7-8, the locking device 36 has a first sub-assembly 52 for the first shutter 24 and a second sub-assembly 54 for the second shutter 26. Each sub-assembly 52 has opposing clips 56, 58 and an elongated retention bracket 60. Each clip 56, 58 preferably has a web portion 62 that spans between inside and outside leg portions 64, 66 of the clips 56, 58. The inside and outside leg portions 64, 66 and the web portion 62 cooperate to define a cavity 98 for receiving one of the edge faces 51 of the respective shutter 24, 26. A hole 68 is substantially centered in each web portion 62 and a pair of notches 69 in each leg portion 64, 66 are located in the clips 56, 58 for selective receipt of a fastener 70 such as a screw to secure the clips 56, 58 firmly to the shutters 24, 26.

Referring to FIGS. 2-6 and 9-10, the retention bracket 60 is preferably made of extruded aluminum and has an inner channel 72 defined between a mid plate 74 and at least one and preferably two base plates 76 generally located directly against the shutters. An elongated passage 78 of the retention bracket 60 communicates longitudinally or axially through at least the inside ends of the bracket 60. The passage 78 has a first segment 80 disposed generally planar to the channel 72 with the mid plate 74 located there between and a second segment 82 orientated substantially perpendicular to the first segment 80 and communicating laterally inward with the first segment 80 and opened laterally outward. The first segment 80 of the elongated passage 78 is defined between the mid plate 74 and a substantially parallel outer plate 75 that is bisected longitudinally by the second segment 82. The second segment 82 is defined between parallel lips 77 that project laterally outward from the outer plate 75. The mid plate 74 carries a series of longitudinally extending ribs 83 that project laterally into the first segment 80 of the passage 78 for providing a slip fit of a rigidity member 84 of the locking device 36.

Referring to FIGS. 5, 6, and 11, the elongated rigidity member 84 is preferably T-shaped in lateral cross section having a substantially planar first portion 86 and a transverse second portion 88 projecting laterally outward from a mid point of the first portion 86 and to a distal edge 90 of the second portion 88.

During assembly of the locking device 36, only one individual is generally required to assemble the assembly 20 and thus lock the shutter set 22 in the closed position 34. For ease of explanation, assembly of sub-assembly 52 to shutter 24 will be described with the knowledge that assembly of sub-assembly 54 to shutter 26 is generally the same. Moreover and as illustrated, sub-assembly 52 will be described as mounted to the outside of shutter 24 when closed. However, a similar procedure may be followed to mount on the inside.

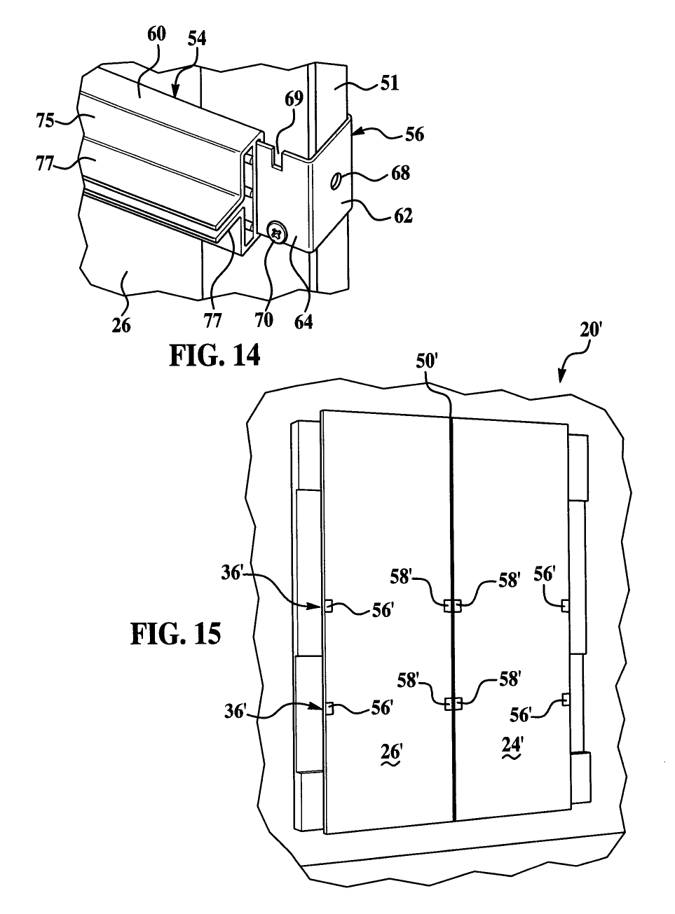

To assemble, the retention bracket 60 of sub-assembly 52 is preferably field cut from extruded stock and to an appropriate length that is slightly less than the width of the shutter 24. Prior to closing the shutter set 22, the sub-assembly 52 is attached to shutter 24 by first engaging the outside clip 56 to the shutter 24 at the outside edge face 51 (see FIG. 13). Alternatively, and preferably with the shutter 24 closed, the outside clip 56 can be secured to the shutter 24 by partially screwing the fastener or screw through the outside surface 44. The clip 56 is then slid downward until the threaded shank portion of the screw 70 is received through the open end of the bottom notch 69 (generally see FIG. 14). One skilled in the art would now know that the clips 56, 58 are interchangeable and the notches 69 allow the clips to be hung from either the inside or the outside of the shutters 24, 26. When so selectively engaged, the inside leg 64 is held against the inside surface 42 of the shutter 24 and the web portion 62 is held by the installer against the outside edge face 51 until the screw 70 is inserted through hole 68 and threaded or screwed into the shutter 24 through face 51.

When clip 56 is secured, the outside leg 66 is spaced slightly from the outside surface 44 of shutter 24 by a distance equal to or slightly less than the thickness of the base plate 76 of the retention bracket 60. The installer then urges the open end of the pre-cut bracket 60 against the projecting leg 66. Preferably, the leg 66 slightly flexes resiliently outward to orientate itself into the channel 72 of the bracket 60 and in a press fit arrangement. When so assembled, a portion of the base plate 76 is located directly and snugly between the outside surface 44 of shutter 24 and the outside leg 66 of clip 56.

With the bracket 60 secured to clip 56, the installers hands are free to attach the clip 58 in a similar selective fashion to the opposite end of the bracket 60 and against the inside edge face 48, outside surface 44, or inside surface 44 of shutter 24. Alternatively, the provided clip 58 is snugly fitted sufficiently to withstand forces of gravity. In this embodiment, a fastener is optional for holding the respective bracket 60 end up for later alignment with the rigidity member 84.

With both sub-assemblies 52, 54 assembled, the rigidity member 84 of locking device 36 is preferably field cut to length from extruded stock preferably made of aluminum. The length of member 84 is preferably slightly less than the widest of the two shutters 24, 26. Because shutter pairs are typically of equal widths, the length of member 84 is slightly less than the length of either bracket 60. Prior to completely closing the shutter set 22, the rigidity member 84 is slid completely into the passage 78 through an open, inside, end of the bracket 60 of either sub-assembly 52, 54. When inserted, the first portion or flange 86 of the rigidity member 84 is snugly and slidably fitted in the first segment 80 of the passage 78 and the second portion or fin 88 projects laterally outward from the second segment 82 of the passage 78.

The shutters 24, 26 are then closed thus forming the gap 50 between inside edge faces 48. The width of gap 50 is slightly greater than twice the thickness of the web portion 62 of inside clips 58, thus providing sufficient clearance for the clips so that the shutters can close. The installer then grasps the distal edge 90 of the fin 88 that projects laterally outward from the bracket 60. The rigidity member 84 is then slid partly into the other of the two brackets 60 thus crossing over the gap 50 of the shutter set 22. Preferably, the rigidity member 84 is centered across the gap 50 so that half the longitudinal length of the member 84 is in the bracket of the first sub-assembly 52 and the other half is in the bracket of the second sub-assembly 54. This means that the rigidity member 84 interconnects the retention bracket 60 of the first sub-assembly 52 to the retention bracket 60 of the second sub-assembly 54.

With the rigidity member 84 centered, at least one pin 92, preferably having a pull-ring is inserted through aligned holes 94, 96 in the parallel lips 77 of the respective bracket 60 and rigidity member 84. It should be appreciated, however, that other fasteners known to those skilled in the art can also be used. The snug fit of the clips 56, 58 to the shutters 24, 26 and the brackets 60, and the snug fit of the rigidity member 84 in the brackets 60 prevents excessive rattling of the shutter set 22 during inclement whether. The limited length of the rigidity member 84 is ideal when portions of the building 28 project further outward and about the opening 30 than the sub-assemblies 52, 54 themselves. One skilled in the art, however, would now know that if the building 28 is generally receded inward from the brackets 60 (i.e. the brackets are located outward the exterior wall of the building 28), the length of the rigidity member 84 may be substantially equal to the length of both brackets 60 combined. Moreover, one skilled in the art would also know that use of fasteners 70 may not be required if the resilient strength of the clips 56, 58 is strong enough to prevent the locking device 36 from slipping downward, and/or if the shutters carry protuberances to prevent such slippage.

When the shutter set 22 is in the open position 32, the rigidity member 84 can be slid completely into either bracket 60 for storage and secured in place with one of the two pins 92 when holes 94, 96 are re-aligned. The other pin 92 may be stored in the other bracket 60 of the other shutter by inserting the pin 92 into hole 94.

Referring to FIG. 15 a second embodiment of an assembly is illustrated wherein like components to the first embodiment have like identifying numerals except with the addition of a prime symbol. In the second embodiment, the shutter set is replaced with french doors and two locking devices 36′ are used instead of one. Preferably, the first locking device is placed in the center of the french doors 22′ and the second locking device 36′ is placed about one third of the way up from the bottom of the french doors 22′.

Although the preferred embodiment of the present invention has been disclosed, various changes and modifications may be made thereto by one skilled in the art without departing from the scope and spirit of the invention as set forth in the appended claims. For instance, the locking device 36 is interchangeable between opposite surfaces 42, 44 of the shutter set 22. It can thus be installed from either the inside or outside of the building 28. It is also understood that the terms used herein are merely descriptive, rather than limiting, and that various changes may be made without departing from the scope and spirit of the invention.

What is claimed is:

1. A shutter sub-assembly for locking a first and a second shutter in a closed position on a structure, said sub-assembly comprising:
a first retention bracket extending between a first and a second end and defining a passage extending between said ends with said first retention bracket for attachment to the first shutter;
a second retention bracket extending between a first and a second end and defining a passage extending between said ends with said second retention bracket for attachment to the second shutter with said first end of said second retention bracket for disposition adjacent said second end of said first retention bracket to align said passage of said first retention bracket with said passage of said second retention bracket;
a rigidity member extending longitudinally and for sliding engagement within said passage of said first and second retention bracket to interconnect said first retention to said section retention bracket and restrain movement of the shutters with respect to the structure.

2. A shutter sub-assembly as set forth in claim 1 further comprising a clip for interconnecting said first retention bracket to the first shutter to retain said first retention bracket to the first shutter.

3. A shutter sub-assembly as set forth in claim 2 wherein said clip includes a web portion spanning between a first leg portion and a second leg portion with said web portion, said first leg portion, and said second leg portion cooperating to define a cavity for receiving a face of the first shutter.

4. A shutter sub-assembly as set forth in claim 3 wherein said web portion defines a hole for receiving a fastener to secure said clip to the first shutter.

5. A shutter sub-assembly as set forth in claim 3 wherein said leg portions each define a notch for selective receipt of a fastener to secure said clip to one of the shutters.

6. A shutter sub-assembly as set forth in claim 2 wherein said clip is further defined as a pair of clips with said clips for engaging said first and said second ends of said one of said first and said second retention bracket.

7. A shutter sub-assembly as set forth in claim 3 wherein said first leg portion of said clip is for engaging said first end of said first retention bracket to retain said first retention bracket to the first shutter.

8. A shutter sub-assembly as set forth in claim 3 wherein said clip is further defined as a first clip and a second clip where said first leg portion of said first clip is for engaging said first end of said first retention bracket and said first leg portion of said second clip is for engaging said second end of said first retention bracket with the first shutter including a first face and a second face opposite the first face and with the cavity of said first clip for receiving the first face of the first shutter the cavity of said second clip for receiving the second face of the first shutter.

9. A shutter sub-assembly as set forth in claim 8 wherein each of said retention brackets include a mid plate and a pair of base plates extending from said mid plate in spaced relationship with said base plates curving toward one another and said mid plate and said pair of base plates cooperating to define an inner channel for receiving said first leg of said first clip in said inner channel of said first clip and said first leg of said second clip in said inner channel of said second clip to retain one of said retention brackets to the respective shutter.

10. A shutter sub-assembly as set forth in claim 3 wherein each of said retention brackets include at least one rib extending into said passage for engaging said rigidity member to provide a slip fit between said rigidity member and said retention bracket.

11. A shutter sub-assembly as set forth in claim 2 wherein said retention bracket includes a mid plate and a pair of outer plates extending from said mid plate in spaced relationship and a pair of walls interconnecting said mid plate to said outer plate with said mid plate, said pair of outer plates and said walls cooperating to define a first segment of said passage for receiving at least a portion of said rigidity member.

12. A shutter sub-assembly as set forth in claim 11 wherein said retention bracket further includes a lip extending transversely from each of said outer plates in spaced and parallel relationship to define a second segment of said passage for receiving at least a portion of said rigidity member in said first segment and said second segment of said passage.

13. A shutter sub-assembly as set forth in claim 12 wherein said rigidity member includes a first portion and a second portion extending transversely from said first portion to form a T-shaped cross section for disposition of said first portion in said first segment of said retention bracket and said second portion in said second segment of said retention bracket.

14. A locking shutter assembly, said assembly comprising:
a first shutter for attachment to a building structure;
a first retention bracket extending between a first and a second end and defining a passage extending between said ends with said first retention bracket disposed on said first shutter;
a second shutter for attachment to the building structure, adjacent said first shutter;
a second retention bracket extending between a first and a second end and defining a passage extending between said ends with said second retention bracket disposed on said second shutter with said first end of said second retention bracket disposed adjacent said second end of said first retention bracket such that said passages of said first and said second retention brackets are aligned to form a single continuous passage; and
a rigidity member disposed in said single continuous passage of said first and said second retention bracket and interconnecting said first retention bracket to said second retention bracket and restrain movement of said shutters with respect to the structure.

15. A locking shutter assembly as set forth in claim 14 further comprising a clip interconnecting said first retention bracket and said first shutter to retain said first retention bracket to said first shutter.

16. A locking shutter assembly as set forth in claim 15 wherein said clip includes a web portion spanning between a first leg portion and a second leg portion with said web portion, said first leg portion, and said second leg portion cooperating to define a cavity with a face of said first shutter inserted within said cavity.

17. A locking shutter assembly as set forth in claim 16 wherein said web portion defines a hole for receiving a fastener through said hole and into said face of said first shutter to secure said clip to said first shutter.

18. A locking shutter assembly as set forth in claim 16 wherein said first and said second leg portions define at least one notch with a fastener inserted through said notch and into said first shutter to secure said clip to said first shutter.

19. A locking shutter assembly as set forth in claim 16 wherein said first leg portion of said clip engages said first end of said first retention bracket to retain said first retention bracket to said first shutter.

20. A locking shutter assembly as set forth in claim 16 wherein said clip is further defined as a first clip and a second clip wherein said first leg portion of said first clip engages said first end of said first retention bracket and said first leg portion of said second clip engages said second end of said first retention bracket with said first shutter including a first face and a second face opposite said first face and with said first face disposed in said cavity of said first clip and said second face disposed in said cavity of said second clip.

21. A locking shutter assembly as set forth in claim 20 wherein each of said retention brackets include a mid plate and a pair of base plates extending from said mid plate in spaced relationship with said base plates curving toward one another and said mid plate and said pair of base plates cooperating to define an inner channel with said first leg of said first clip received in said inner channel of said first clip and said first leg of said second clip received in said inner channel of said second clip to retain one of said retention brackets to said respective shutter.

22. A locking shutter assembly as set forth in claim 15 wherein each of said retention brackets include at least one rib extending into said passage and said rib engaging said rigidity member for providing a slip fit between said rigidity member and said retention bracket.

23. A locking shutter assembly as set forth in claim 14 wherein said retention bracket includes a mid plate and a pair of outer plates extending from said mid plate in spaced relationship and a pair of walls interconnecting said mid plate to said outer plate with said mid plate, said pair of outer plates and said walls cooperating to define a first segment of said passage and with at least a portion of said rigidity member disposed in said first segment of said passage.

24. A locking shutter assembly as set forth in claim 23 wherein said retention bracket further includes a lip extending transversely from each of said outer plates in spaced and parallel relationship to define a second segment of said passage with at least a portion of said rigidity member disposed in said first segment and said second segment of said passage.

25. A locking shutter assembly as set forth in claim 24 wherein said rigidity member includes a first portion and a second portion extending transversely from said first portion to form a T-shaped cross section with said first portion disposed in said first segment of said retention bracket and said second portion disposed in said second segment of said retention bracket.

26. A method of locking shutters in a closed position to cover an opening on a structure, said method comprising the steps of:
attaching a first retention bracket to a first shutter where the first retention bracket defines a passage;
attaching a second retention bracket to a second shutter where the second retention bracket defines a passage; and
sliding an elongated rigidity member through the passages of both of the first and the second retention bracket to lock the shutters in the closed position.

27. A method as set forth in claim 26 further comprising the steps of:
attaching a clip to a first edge of the first shutter;
inserting a portion of the clip into a first end of the first retention bracket to retain the first retention bracket to the first shutter;
attaching a clip to a second edge of the second shutter; and
inserting a portion of the clip into a first end of the second retention bracket to retain the second retention bracket to the second shutter.

28. A method as set forth in claim 27 further comprising the step of fastening each of the clips to the respective first and second shutters.

29. A method as set forth in claim 27 further comprising the steps of:
attaching an opposing clip to a second edge of the first shutter;
inserting a portion of the opposing clip into a second end of the first retention bracket to retain the first retention bracket to the first shutter;
inserting an opposing clip to a second edge of the second shutter;
sliding a portion of the opposing clip into a second end of the second retention bracket to retain the first retention bracket to the second shutter.

30. A method as set forth in claim 27 wherein the first retention bracket and the rigidity member define a hole extending there through and said method further comprises the step of inserting a pin through the hole to retain the rigidity member to the first retention
